(19) United States
(12) Patent Application Publication
(10) Pub. No.: US 2017/0179728 A1
(43) Pub. Date: Jun. 22, 2017

(54) ELECTROMAGNETIC INDUCTION APPARATUS FOR POWER TRANSFER

(71) Applicants: Keqin Jiang, Shanghai (CN); Edward Tao Gao, Las Vegas, NV (US); Zheng Chen, Shanghai (CN)

(72) Inventors: Keqin Jiang, Shanghai (CN); Edward Tao Gao, Las Vegas, NV (US); Zheng Chen, Shanghai (CN)

(21) Appl. No.: 14/971,490

(22) Filed: Dec. 16, 2015

(51) Int. Cl. H02J 5/00; H01F 38/18

(52) U.S. Cl. CPC H02J 5/005; H01F 38/18

(57) ABSTRACT

An electromagnetic induction apparatus for power transfer may include a first portion and a second portion. The first portion has at least one loop of central coil is winded on the central magnetic core, and the second portion has at least one loop of toroidal core winded on the toroidal magnetic core. When the first portion is inserted into the second portion, the toroidal coil is located around an outside periphery of the central coil. Since the central coil and the toroidal coil are mutual inductance on the same magnetic core, the electromagnetic induction efficiency is improved, leading to enhancing more than 50% of the power transmitted rate.

### FIELD OF THE INVENTION

The present invention relates to an electromagnetic induction apparatus, and more particularly to an electromagnetic induction apparatus for power transfer.

### BACKGROUND OF THE INVENTION

Electromagnetic induction is a typical method for power transfer by a phenomenon of electromagnetic coupling. Since the electromagnetic induction method can transfer power without metals contact, it is considered safer and reliable.

However, the conventional electromagnetic induction apparatus is disadvantageous because of: (i) lower loading capacity; and (ii) lower efficiency. Therefore, there remains a need for a new and improved design for an electromagnetic induction apparatus for power transfer to overcome the problems presented above.

### SUMMARY OF THE INVENTION

The present invention provides an electromagnetic induction apparatus, which comprises a first portion and a second portion. The first portion has a first shell, and a central magnetic core is formed inside of the first shell. Also, at least one loop of central coil is formed on the central magnetic core. The second portion comprises a second shell, and a toroidal magnetic core is formed inside of the second shell. Moreover, at least one loop of toroidal coil is formed on the toroidal magnetic core. When the first portion is inserted into the second portion, the toroidal coil is located around an outside periphery of the central coil. The toroidal magnetic core comprises a magnetic sleeve, and the toroidal coil is secured inside of the magnetic sleeve. Also, each of two lateral sides of the toroidal coil has a magnetic ring. Furthermore, the first portion comprises a first induction coil and a second induction coil, which are configured to cooperate with the central coil. The central coil is electrically connected to a power input through a switching circuit, and also the first induction coil and the second induction coil are electrically connected to a control portion or a positive feedback activated portion of the switching circuit.

In the present invention, the central coil is referred to a primary coil, and the toroidal coil is referred to a secondary coil. When the first portion is inserted into the second portion, the toroidal coil is located around an outside periphery of the central coil. In this structure, a coupling coefficient between the primary coil and the secondary coil is maximized, and also the coupling coefficient is a relative constant. Since the primary coil and the secondary coil are mutual inductance on the same magnetic core, the coupling coefficient is irrelative to both the magnetic flux and the magnetic permeability of an iron core (the iron core is the central magnetic core before passing through by current). The magnetic-feedback effects caused by the iron core only determines the inductances of the primary coil and the secondary coil. Thus, the primary coil and the secondary coil are mutual inductance on central magnetic core as long as a driving frequency or a pulse duration is matched with the inductances of the primary coil and the secondary coil. Also, a gap between the central magnetic core and the toroidal magnetic core will not affect the power transmitted rate, power transmitted efficiency. Comparing with the conventional electromagnetic induction apparatus, the electromagnetic induction efficiency is improved, leading to enhancing more than 50% of the power transmitted rate.

### BRIEF DESCRIPTION OF THE DRAWINGS

FIG. 1 is a schematic view of the first portion of the electromagnetic induction apparatus for power transfer in the present invention.

FIG. 2 is a schematic view of the second portion of the electromagnetic induction apparatus for power transfer in the present invention.

FIG. 3 is a schematic view of the electromagnetic induction apparatus for power transfer in the present invention, when the first portion is connected to the second portion.

FIG. 4 is a circuit diagram of the electromagnetic induction apparatus for power transfer in the present invention.

### DETAILED DESCRIPTION OF THE INVENTION

The detailed description set forth below is intended as a description of the presently exemplary device provided in accordance with aspects of the present invention and is not intended to represent the only forms in which the present invention may be prepared or utilized. It is to be understood, rather, that the same or equivalent functions and components may be accomplished by different embodiments that are also intended to be encompassed within the spirit and scope of the invention.

Unless defined otherwise, all technical and scientific terms used herein have the same meaning as commonly understood to one of ordinary skill in the art to which this invention belongs. Although any methods, devices and materials similar or equivalent to those described can be used in the practice or testing of the invention, the exemplary methods, devices and materials are now described.

All publications mentioned are incorporated by reference for the purpose of describing and disclosing, for example, the designs and methodologies that are described in the publications that might be used in connection with the presently described invention. The publications listed or discussed above, below and throughout the text are provided solely for their disclosure prior to the filing date of the present application. Nothing herein is to be construed as an admission that the inventors are not entitled to antedate such disclosure by virtue of prior invention.

In order to further understand the goal, characteristics and effect of the present invention, a number of embodiments along with the drawings are illustrated as following:

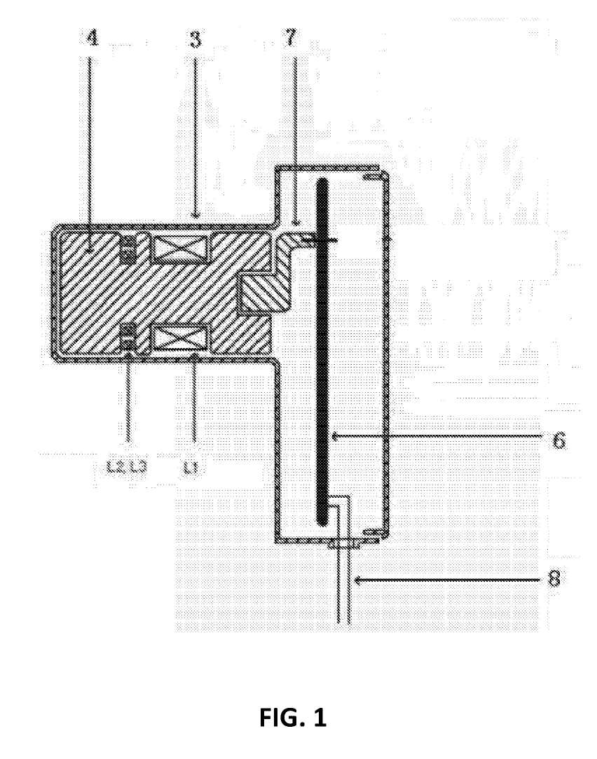

Referring to FIGS. 1 to 4, the present invention provides an electromagnetic induction apparatus, which comprises a first portion (1) and a second portion (2). The first portion (1) has a first shell (3), and a central magnetic core (4) is formed inside of the first shell (3). Also, at least one loop of central coil (L1) is formed on the central magnetic core (4). The second portion (2) comprises a second shell (10), and a toroidal magnetic core is formed inside of the second shell (10). Moreover, at least one loop of toroidal coil (L4) is formed on the toroidal magnetic core. In the present invention, the central coil (L1) is referred to a primary coil, and the toroidal coil (L4) is referred to a secondary coil. When the first portion (1) is inserted into the second portion (2), the toroidal coil (L4) is located around an outside periphery of the central coil (L1). Thus, the primary coil and the secondary coil are inductively coupling on the same magnetic core. The toroidal magnetic core comprises a magnetic sleeve (14), and the toroidal coil (L4) is secured inside of the magnetic sleeve (14). Also, each of two lateral sides of the toroidal coil (L4) has a magnetic ring (13). Furthermore, the first portion comprises a first induction coil (L2) and a second induction coil (L3), which are configured to cooperate with the central coil (L1). In the present invention, the first induction coil (L2) is a first feedback coil (L2), and the second induction coil (L3) is a second feedback coil (L3). The central coil (L1) is electrically connected to a power input through a switching circuit, and also the first induction coil (L2) and the second induction coil (L3) are electrically connected to a control portion or a positive feedback activated portion of the switching circuit.

Referring to FIG. 1, the central magnetic core (4) formed inside of the first shell (3) is shaped into a column, and two loop slots formed at different sections of the central magnetic core (4) are configured to be winded by the central coil (L1) and the first and second induction coil (L2)(L3). Also, the first portion (1) comprises a switching circuit conversion board (6) formed inside of the first shell (3), and the central coil (L1) and the first and second induction coil (L2)(L3) are electrically connected to the switching circuit conversion board (6) through a coil leading wire (7). Moreover, the switching circuit conversion board (6) is electrically connected to a power input wire (8). Thus, the electric power from the power input wire (8) passes through the switching circuit conversion board (6), and is transformed into a higher frequency current to drive the toroidal coil (L4) on the second portion (2). Therefore, relative alternating magnetic fields are generated between the central magnetic core (4) and the toroidal magnetic core, and the first and second induction coil (L2)(L3) are configured as excitation signals of the self-excited oscillation or the feedback control on the switching circuit conversion board (6). Also, each of inside spaces of the first shell (3) and the second shell (10) are infilled with the resin to achieve the effect of waterproof.

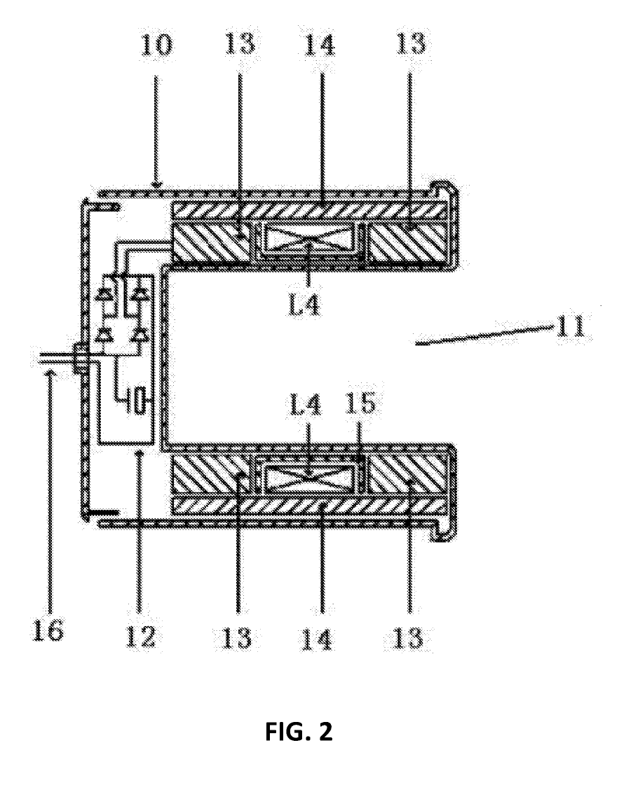

Referring to FIG. 2, the second portion comprises the toroidal magnetic core formed inside of the second shell (10), and the toroidal coil (L4) is winded on the toroidal magnetic core. A socket (11) formed on the second shell (10) is configured to receive the first portion (1). An outer periphery of the socket (11) has a toroidal coil skeleton (15), and the toroidal coil (L4) is winded thereon. Each of the two lateral side of the toroidal coil (L4) comprises the magnetic ring (13), and the magnetic sleeve (14) is covered around outside peripheries of the toroidal coil (L4) and the magnetic rings (13). A power outlet wire (16) passes through a rectifier filter circuit to electrically connect to the toroidal coil (L4), and the space inside of the second shell (10) is infilled with the resin to achieve the effect of waterproof. The alternating magnetic field provided from the first portion (1) induces an electric potential on the toroidal coil (L4) which is referred as the secondary coil. Then, the induced electric potential is filtered and rectified, and passes out of the second portion (2) through the power output wire (16).

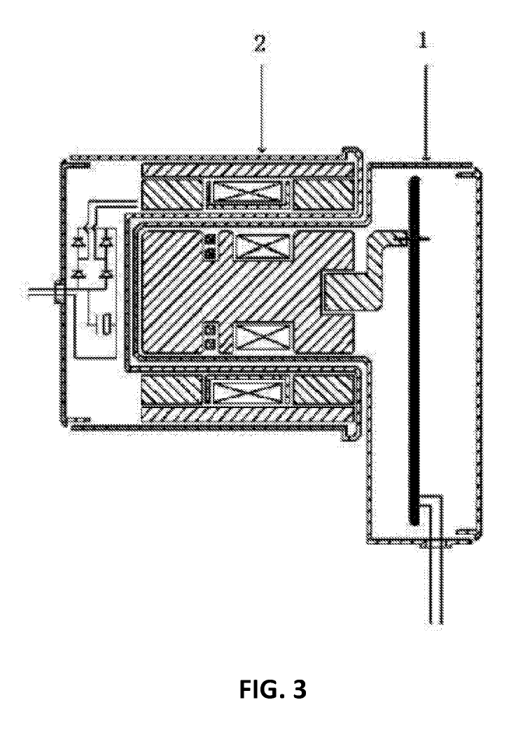

Referring to FIG. 3, when the first portion (1) is inserted into the second portion (2), the electric energy is transmitted from the first portion (1) to the second portion (2) through the magnetic induction. The electric energy from the power input wire (8) passes through the central coil (L1) of the first portion (1), which is referred to the primary coil of the transformer equivalent circuit, and then the electric energy induces the central coil (L1) to generate the magnetic energy. The induced magnetic energy induces the toroidal coil (L4) of the second portion (2), referred to the secondary coil, to transform into the electric energy on the second portion (2). In transformed process mentioned above, the electric energy consumed by an electrical load is equal to the magnetic energy consumed by the toroidal coil (L4), so that the magnetic coupling and the magnetic leakage occurred between the central coil (L1) and the toroidal coil (L4) are much important for the power transmitted rate and power transmitted efficiency. When the first portion (1) is inserted into the second portion (2), the secondary coil is located around the outside periphery of the primary coil (as shown in FIG. 3). Thus, the primary coil and the secondary coil are inductively coupling on the central magnetic core (4). In this structure, a coupling coefficient between the primary coil and the secondary coil is maximized, and also the coupling coefficient is a relative constant (the structure also can be that the primary coil is located around an outside periphery of the secondary coil). Since the primary coil and the secondary coil are mutual inductance on the same magnetic core (the central magnetic core (4)), the coupling coefficient is irrelative to both the magnetic flux and the magnetic permeability of an iron core (the iron core is the central magnetic core (4) before passing through by current). The magnetic-feedback effects caused by the iron core only determines the inductances of the primary coil and the secondary coil. Thus, the primary coil and the secondary coil are mutual inductance on central magnetic core (4) as long as a driving frequency or a pulse duration is matched with the inductances of the primary coil and the secondary coil. Also, a gap between the central magnetic core (4) and the toroidal magnetic core will not affect the power transmitted rate, power transmitted efficiency and the magnetic circuit generated between the first portion (1) and the second portion (2).

Because of the present invention comprising the first shell (3) of the first portion (1) and the second shell (10) of the second portion (2), both of a distance between the primary coil and the secondary coil, and a distance between the central magnetic core (4) and the toroidal magnetic core are increased, leading to increasing the magnetic leakage occurred between the primary coil and the secondary coil, and a magnetic resistance between the central magnetic core and toroidal magnetic core. Therefore, the present invention provides following improvements to overcome the problems presented above.

The present invention provides the magnetic sleeve (14), the magnetic rings (13), and the central magnetic core (4) to prevent the electromagnetic induction apparatus from the occurrence of magnetic leakage. The central magnetic core (4) served as a center is combined with the magnetic rings (13) and the magnetic sleeve (14), which are served as magnetic loops, and the magnetic circuit generated between the central magnetic core (4), magnetic rings (13) and the magnetic sleeve (14) is able to overcome the magnetic leakage occurred between the primary coil and the secondary coil. Moreover, the present invention increases areas of the magnetic coupling by extending axial lengths of the magnetic rings and axial lengths of six protruding portions from both lateral sides of the central magnetic core, resulting in lowering the magnetic resistance generated from the gap between the central magnetic core (4) and the toroidal magnetic core and increasing the magnetic flux of the magnetic circuit. Since the magnetic circuit is evenly distributed on an axial circumference of the magnetic sleeve (4), a wall of the magnetic sleeve (4) is thinner, leading to reducing the volume of an outlet. Further, by increasing the driving frequency properly, the present invention can improve the magnetic coupling and achieve the inductance need, leading to increasing the electrical load. In one embodiment, the thickness of each of the first shell (4) and the second shell (10) is approximately 1 mm, and thus a distance between the central coil (L1) of the first portion (1) and the toroidal coil (L4) of the second portion (2) is 2-3 mm. Also, a diameter of the central magnetic core (4) is 14-18 mm, and each of a depth and a length of the loop slot for the central coil (L1) is 3-5 mm and 8-12 mm respectively. An axial length of the toroidal coil (L4) is 20-24 mm, and an axial length of each of the magnetic rings is 8-12 mm. Moreover, axial length of each of two ends of the central magnetic core is 8-12 mm, and a thickness of each of a wall of the magnetic rings is 3-5 mm while a thickness of the wall of the magnetic sleeve is 1-3 mm. When the electromagnetic induction apparatus is applied with above dimensions, the power transmitted rate between the first portion (1) (referred as a plug) and the second portion (2) (referred as an outlet) is able to reach over 25 watts.

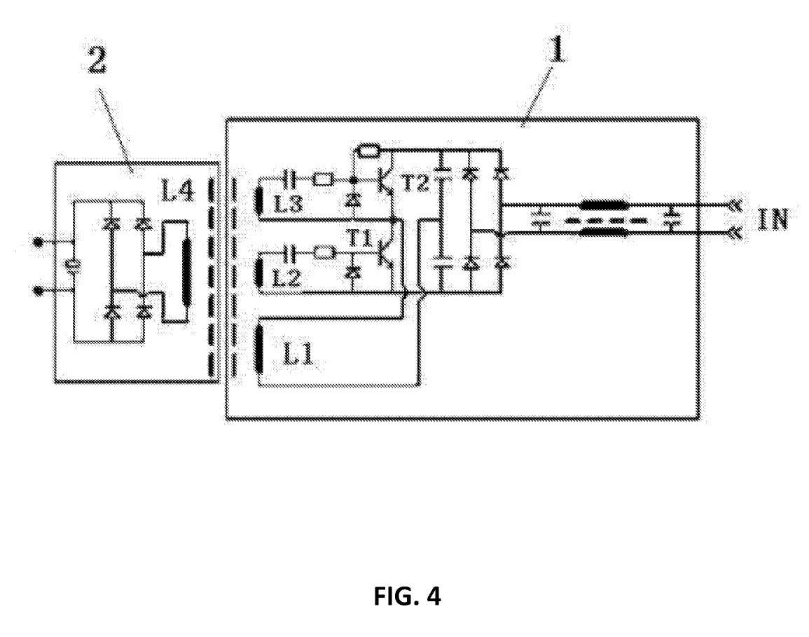

Referring to FIG. 4, Even when the first portion (1) is disconnected from the second portion (2), the power input is still transmitted into the first portion (1), resulting in waste of energy and magnetic pollution. To avoid the circumstance mentioned above, the present invention provides feedback coils which is cooperated with the central coil (L1) (primary coil) in the first portion (1). The feedback coils comprise a first feedback coil (L2) and a second feedback coil (L3). Each of the first feedback coil (L2) and the second feedback coil (L3) is electrically connected to a first control portion of the switching circuit and a second control portion of the switching circuit respectively. The power input is electrically connected to an input end of a rectifier circuit, and an output end of a rectifier circuit passes through the first control portion and the second control portion to electrically connect to the central coil (L1).

When the first portion (1) is inserted into the second portion (2), the magnetic loop is formed between the central magnetic core (4) and the toroidal magnetic core. Also, the primary coil (L1), the secondary coil (L4), the first feedback coil (L2) and the second feedback coil (L3) are in the same magnetic loop. When the electric energy passes through the primary coil (L1), the secondary coil (L4) is electromagnetically induced, leading to the electric energy passing from the first portion (1) to the second portion (2). Meanwhile, the first feedback coil (L2) and the second feedback coil (L3) are induced to generate electric potential which induces the switching circuit to achieve on/off operation or to generate oscillation, leading to the current continuing to pass through the primary coil (L1) (as shown in FIG. 4).

In actual application, the present invention comprises a first switching circuit and a second switching circuit which are a first transistor (T1) and a second transistor (T2) respectively. A first end of the first feedback coil (L2) is connected to a first emitter of the first transistor (T1), and a second end thereof is electrically connected to a first base of the first transistor (T1), and a first capacitor and a first resistor are electrically connected between the second end of the first feedback coil (L2) and the first base of the first transistor (T1). A first end of the second feedback coil (L3) is connected to a second emitter of the second transistor (T2), and a second end thereof is electrically connected to a second base of the second transistor (T2), and a second capacitor and a second resistor are electrically connected between the second end of the second feedback coil (L3) and the second base of the second transistor (T2). A first end of the rectifier circuit is electrically connected to the first emitter of the first transistor (T1), and a first connector of the first transistor (T1) is electrically connected to the second emitter of the second transistor (T2). Also, a second end of the rectifier circuit is electrically connected to a second connector of the second transistor (T2). A first end of the central coil (L1) is electrically connected to the first connector of the first transistor (T1), and a second end thereof is electrically connected to the first capacitor, the second capacitor and two output ends of the rectifier circuit.

In one embodiment, because of the power input is electrically connected to the first portion (1), the primary coil, the first feedback coil, and the second feedback coil are located in the first portion (1), and the secondary coil is located in the second portion (2). On the other hand, when the power input is electrically connected to the second portion (2), the primary coil, the first feedback coil, and the second feedback coil are located in the second portion (2), and the secondary coil is located in the first portion (1).

Having described the invention by the description and illustrations above, it should be understood that these are exemplary of the invention and are not to be considered as limiting. Accordingly, the invention is not to be considered as limited by the foregoing description, but includes any equivalents.

What is claimed is:

1. An electromagnetic induction apparatus for power transfer comprising a first portion and a second portion, the first portion having a first shell, and a central magnetic core formed inside of the first shell, at least one loop of central coil winded on the central magnetic core, the second portion comprising a second shell, and a toroidal magnetic core formed inside of the second shell, at least one loop of toroidal coil winded on the toroidal magnetic core, when the first portion inserted into the second portion, the toroidal coil located around an outside periphery of the central coil.

2. The electromagnetic induction apparatus for power transfer of claim 1, wherein the toroidal magnetic core comprises a magnetic sleeve, and the toroidal coil is secured inside of the magnetic sleeve, and each of two lateral sides of the toroidal coil has a magnetic ring.

3. The electromagnetic induction apparatus for power transfer of claim 2, wherein the first portion comprises a first induction coil and a second induction coil, which are configured to cooperate with the central coil, and the central coil is electrically connected to a power input through a switching circuit, and also the first induction coil and the second induction coil are electrically connected to a positive feedback activated portion of the switching circuit.

4. The electromagnetic induction apparatus for power transfer of claim 3, wherein each of the first induction coil and the second induction coil is a first feedback coil and a second feedback coil, and the switching circuit comprises a first electronic switch and a second electronic switch, wherein the first feedback coil is electrically connected to a first control portion of the first electronic switch, and the second feedback coil is electrically connected to a second control portion of the second electronic switch, wherein the power input is connected to an input end of a rectifier circuit, and an output end of the rectifier circuit is electrically connected through the first electronic switch and the second electronic switch to the central coil.
